(19) United States
(12) Patent Application Publication
(10) Pub. No.: US 2026/0037186 A1
(43) Pub. Date: Feb. 5, 2026

(54) MANAGING DATA PLACEMENT IN A MEMORY SUB-SYSTEM

(71) Applicant: Micron Technology, Inc., Boise, ID (US)

(72) Inventors: Raja V.S. Halaharivi, Gilroy, CA (US); Suresh Nagarajan, Folsom, CA (US)

(21) Appl. No.: 19/264,771

(22) Filed: Jul. 9, 2025

Related U.S. Application Data
(60) Provisional application No. 63/677,927, filed on Jul. 31, 2024.

(51) Int. Cl. G06F 3/06

(52) U.S. Cl. CPC G06F 3/0659; G06F 3/0622; G06F 3/0679

(57) ABSTRACT

A system includes a memory device and a memory sub-system controller, operatively coupled with the memory device, to perform operations including: receiving, from a host system, a memory access command having one or more associated parameters; determining, using a hardware component of the memory sub-system controller, whether the one or more associated parameters comply with a current flexible data placement (FDP) configuration of the system; and in response to determining that the one or more associated parameters comply with the current FDP configuration of the system, executing the memory access command on an identified segment of the memory device.

### RELATED APPLICATIONS

This application claims the benefit of priority from U.S. Provisional Patent Application No. 63/677,927, filed Jul. 31, 2024, which is incorporated herein by reference.

### TECHNICAL FIELD

Embodiments of the disclosure relate generally to memory sub-systems, and more specifically, relate to managing data placement in a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system, in accordance with some embodiments of the present disclosure.

FIG. 2 illustrates an example virtualization internal management component included in a memory sub-system, in accordance with some embodiments of the present disclosure.

FIG. 3 is chart illustrating different example FDP configurations that can be implemented by the memory sub-system controller in accordance with some embodiments of the present disclosure.

FIG. 4 is a flow diagram illustrating an example of a method to implement managing data placement in a memory sub-system, in accordance with some embodiments of the present disclosure.

FIG. 5 is a block diagram of an example computer system in which embodiments of the present disclosure may operate.

### DETAILED DESCRIPTION

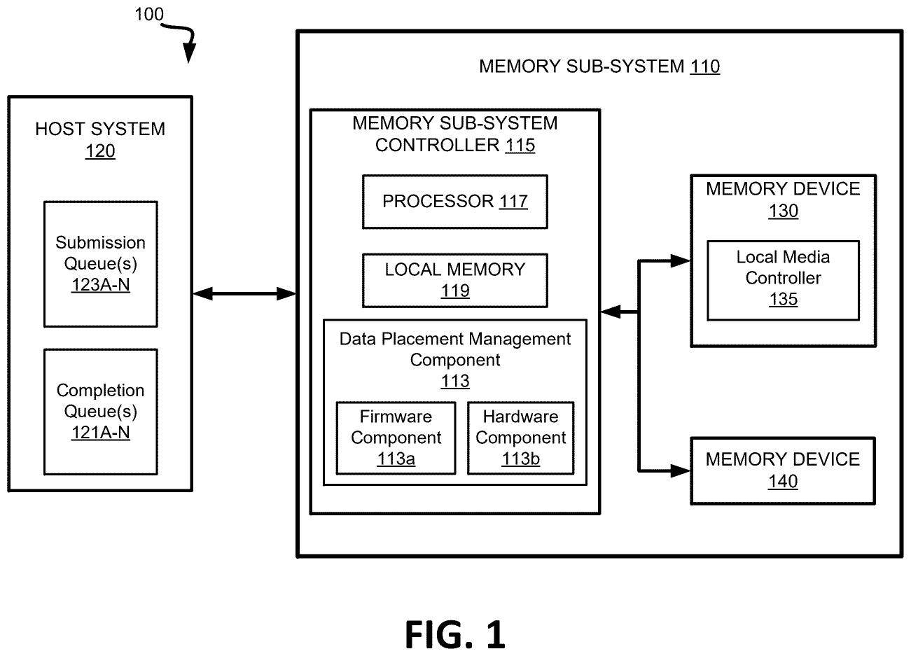

Aspects of the present disclosure are directed to managing data placement in a memory sub-system. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a not-and (NAND) memory device. Other examples of non-volatile memory devices are described below in conjunction with FIG. 1. A non-volatile memory device is a package of one or more dies. Each die includes one or more planes. For some types of non-volatile memory devices (e.g., NAND devices), each plane includes a set of physical blocks. Each block includes a set of pages. Each page includes a set of memory cells. A memory cell is an electronic circuit that stores information. Depending on the memory cell type, a memory cell can store one or more bits of binary information, and has various logic states that correlate to the number of bits being stored. The logic states can be represented by binary values, such as “0” and “1”, or combinations of such values.

Memory access operations can be performed by the memory sub-system. The memory access operations can be host-initiated operations. For example, the host system can initiate a memory access operation (e.g., write, read, erase, etc.) on a memory sub-system. The host system can send memory access commands (e.g., write command, read command) to the memory sub-system, such as to store data at the memory device of the memory sub-system and/or to read data from the memory device of the memory sub-system. A memory sub-system controller can receive the memory access commands from a host system connected externally to the memory sub-system, such as via a Non-Volatile Memory Express (NVMe) interface on a Peripheral Component Interconnect Express (PCIe) communication bus. The memory sub-system can execute the memory access commands to perform the memory access operations and return the results of executing the memory access commands to the host system via the host interface.

The host system can use a logical address space to access the memory device. The logical address space can identify a logical unit, such as a logical block. For some types of memory devices, a logical block is the smallest write/read unit. For example, the size of data in a logical block can be 512 bytes, 4096 bytes (4 KB), etc., depending on the specification of the memory device. In certain memory devices, a logical block can be a group of logical pages. A logical page is an abstraction of physical pages. A memory sub-system can define a logical page to be equal to a particular unit of physical storage (e.g., a physical page, a physical block, etc.). A logical block address (LBA) is an identifier of a logical block. In an addressing scheme for logical blocks, logical blocks can be located using an integer index, with the first block being LBA 0, the second being LBA 1, and so on.

The logical address space can be managed using a translation unit (TU). For certain memory devices, a TU is a base granularity of data managed by the memory device. A TU can include a predefined number of logical units (e.g., logical pages, logical blocks, etc.). In some examples, a TU is predefined to include one logical block, so the size of the TU equals the size of the logical block. In some examples, a TU is predefined to include multiple logical blocks. In that case, the size of the TU is a multiple of the size of the logical blocks.

In one example, a TU can be predefined to include one 512 byte logical block, so the size of the TU is 512 bytes. In another example, a TU can be predefined to include one 4 KB logical block, size the size of the TU is 4 KB. In another example, a TU can be predefined to include eight 512 byte logical blocks, totaling a size of (8*512) bytes, or 4096 bytes (4 KB). In the previous example, the size of the TU is 4 KB. The logical address space can be divided using a number of TUs (e.g., 4 KB size TUs), where each TU can include eight logical blocks. In one addressing scheme for TUs, TUs can be located using an integer index, with the first TU being TU 0, the second TU being TU 1, and so on. In an example, TU O can include eight LBAs starting from LBA 0 and ending at LBA 7. TU 1 can include the next eight LBAs, starting at LBA 8 and ending at LBA 15, and so on. The starting address and the ending address of the logical unit (e.g., logical block, logical page, etc.) can define the boundaries of the TU.

When the host system requests to access data (e.g., read data, write data), the host system can send a memory access command to the memory device directed to the logical address space. For example, the host system can provide logical address information (e.g., logical block address (LBA), namespace) identifying the location where the data is to be stored at or read from. Since the data from the host system is eventually to be stored at a physical address within the memory device, the memory sub-system controller can translate the logical address information to a corresponding TU. The memory sub-system controller maintains a logical to physical (L2P) translation map, or table, to identify the physical location where the data corresponding to each logical address resides. The L2P table can include a number of L2P entries. Each entry in an L2P table can identify a physical location corresponding to a particular TU. The L2P table tracks every TU that has been written to the memory device by maintaining its physical address. For example, an L2P entry can include an index of the TU (e.g., TU 0, TU 1, etc.), a corresponding range of physical addresses, some metadata, such as a flag that indicates whether the data at an address is valid or invalid, etc. The L2P table can be maintained by the firmware of the memory sub-system controller and is stored on one or more non-volatile memory devices of the memory sub-system. The L2P table can be at least partially cached by one or more volatile memory devices of the memory sub-system.

In certain memory devices, the logical address space of the memory device is divided into namespaces that allow for more efficient management of data. Each namespace can be mapped to multiple logical blocks. For example, one or more LBAs can be mapped to a particular namespace. Each namespace can be referenced using a namespace identifier. Each namespace can include a namespace data structure (e.g., a table) that is created, updated, or deleted, e.g., using NameSpace Management and Namespace Attachment commands as defined by the NVMe TPAR-4146 Specification. The namespace data structure can indicate capabilities and settings that are specific to a particular namespace.

The memory sub-system can present one or more physical functions to the host system over the PCIe interface. A physical function can represent a partitioned part of a memory sub-system that is associated with a given host system. A memory sub-system can be partitioned into multiple portions using multiple physical functions. In some systems, the memory sub-system utilizes a specification that allows the isolation of PCIe resources among various hardware functions for manageability and performance reasons, while also allowing single physical PCIe devices to be shared in a virtual environment. A physical function allows the enumeration of a number of virtual functions. The host system, via a hypervisor, can then assign those virtual functions to one or more virtual machines running on the host system. Such a virtual environment thus can provide abstractions of the physical components into logical objects in order to allow for running various software modules, such as, for example, multiple operating systems, concurrently and in isolation from other software modules, on one or more interconnected physical computer systems. Still, in the virtual environment, some media management is in need to render a better performance of the memory sub-system.

For example, a memory sub-system controller can perform media management operations, such as wear leveling, refresh, garbage collection, scrubbing, etc., on a block that includes one or more pages containing valid data while the remaining pages can contain invalid data. To avoid waiting for a threshold number of pages in the block to have invalid data in order to erase and reuse the block, the memory sub-system controller can perform garbage collection operations to allow the block to be erased and released as a free block for subsequent write operations. Garbage collection is a process to recover free space by relocating pages with data to new blocks, and erasing old blocks. Specifically, a block can include valid data pages and data pages that are no longer needed (e.g., stale pages). Garbage collection generally involves copying only the valid data pages from a source block to a destination block and then erasing the source block to free the space. As a result, the number of blocks that have been erased can be increased such that more blocks are available to store subsequent data from a host system. This additional re-write of valid data in the data blocks during a garbage collection operation can result in write amplification. Write amplification manifests itself by the amount of physical data to be written to the storage media being a multiple of the logical amount of data manipulated by the host. Write amplification can reduce the operating life and impact the performance of a memory sub-system.

In the virtual environment, garbage collection and write amplification can lead to the data placement associated with a virtual machine being scattered among multiple blocks, so that data from different virtual machines are mixed together. Such data placement scattering can adversely affect the performance of the memory device and the quality of service (QOS) (e.g., bandwidth, input/output operations per second (IOPS), etc.) associated with a virtual machine, for example, due to the interference of a block used by one virtual machine with an adjacent block used by another virtual machine.

Flexible Data Placement (FDP) is a set of NVM commands as defined by the NVMe TPAR-4146 Specification. FDP can be used to reduce write amplification. Specifically, FDP enables host-guided data placement to allow data to be referenced by a specific placement identifier which in turn points to a reclaim unit (RU). RUs are units of physical, non-volatile storage that can be programmed, read, erased, reused, and/or repurposed without disturbing each other. The specific placement identifier pointing to a RU can include a reclaim unit handle (RUH). The host system can tag a write command with the RUH to identify the RU where the data specified in the write command should be written.

A firmware component of a memory sub-system controller can create multiple namespaces by allocating a set of superblocks (e.g., a reclaim group) to each namespace and assigning a respective handle (e.g., reclaim unit handle) to each namespace. As the superblocks are physically isolated portions of the memory device, the namespace mapped to the superblock can provide the virtual machine with a physically isolated data placement. When the firmware component receives, from a virtual machine running on a host system, a command to perform a write operation associated with a namespace, the firmware component can identify a segment of the memory device based on the handle assigned to the namespace, and perform the operation on the segment of the memory device.

In certain devices, one or more RUs can form a reclaim group (RG), where an RG corresponds to a namespace. As such, an RG can be an addressable data storage unit that includes a predefined number of smaller addressable data storage units of an order that is lower than the RG, and thus the RG can refer to a higher-order data storage unit, while the RU can refer to a lower-order data storage unit. In some examples, a RU can have a granularity of a predefined number of blocks and can be a superblock, and an RG can be a set of superblocks that includes a predefined number of the RU. For example, a RU can be one superblock, and an RG can be a set of superblocks that includes one usable superblock from each plane on a set of dies of a memory device. Each superblock can be located on a separate plane having independent circuitry allowing parallel operations to be performed on the set of superblocks. The RG can be physically isolated from each other to minimize the interference of performance between each other. For example, a first RG is allocated in a first set of dies, e.g., die 1 to die 8, and a second RG is allocated in a second set of dies, e.g., die 9 to die 16, where the first set of dies and the second set of dies are physically isolated to each other.

In certain memory sub-systems, the firmware component of a memory sub-system controller can receive and process a request to create a namespace. Accordingly, the memory sub-system controller can create a namespace by allocating an RG to the namespace. Specifically, the memory sub-system controller can allocate the RG by selecting a set of RUs, where the number of RUs in the set of RUs is predetermined (e.g., with a default value) or determined at the time of creating a virtual machine. After the memory sub-system controller creates one or more namespaces, the memory sub-system controller can assign one RUH to each namespace. The RUH is unique to the specific namespace, and the specific namespace can only have one RUH. Although RUH is used here, other forms of handles, tags, etc. can be used to replace RUH to reference the namespace. The memory sub-system controller can store the assignment between the RUH, the namespace identifier, the set of RUs, and/or the RG allocated to the namespace in a data structure. The memory sub-system controller can use an identifier of the RUH to identify the set of RUs in an RG allocated to a particular namespace. This identifier can be referred to as a Placement Handle Identifier (PHI).

When a virtual machine sends, to the memory sub-system controller, a request to perform a memory access operation associated with a namespace, the firmware component of the memory sub-system controller can use the PHI included in the request to identify the RUH, where the RUH can be further used to identify the RG. The memory sub-system controller can then perform the requested memory access operation on the identified RG. However, by having the firmware component determine the corresponding RG associated with the PHI for each memory access command received from the host system, there can be an impact on system performance by increasing the amount of time and resources the memory sub-system typically takes to process and execute a memory access command.

Aspects of the present disclosure address the above and other deficiencies by managing data placement in a memory sub-system using a hardware component (e.g., a hardware automation component) of a memory sub-system controller. Instead of having the firmware component determine the corresponding RG associated with the PHI for each memory access command received from the host system, the determination of the corresponding RH associated with the PHI can be automated by the hardware component (e.g., the hardware automation component). As such, there can be an improvement in system performance by automating the determination of a corresponding RG associated with a PHI for each memory access command without firmware involvement. In addition, FDP can provide a number of different configurations for different parameters of the memory sub-system which can be selected by the host system depending on the particular implementation. Each configuration, for example, can include a different combination of the maximum number of namespaces (i.e., NS_max) supported in the FDP mode, the maximum number of placement handle identifiers (i.e., PHI_max) supported in the FDP mode, and the maximum number of reclaim groups (i.e., RG_max) supported in the FDP mode. There may be a practical limit to the storage provided by the memory sub-system, such that if one parameter is increased, another parameter may need to be decreased. Thus, the host system can influence the configuration of the memory sub-system in the FDP mode to best suit its needs. When a memory access request is received, the hardware automation component can ensure that the request is in compliance with the selected configuration, and if so, process the request accordingly. If the memory access request is not in compliance with the selected configuration, the hardware automation component may pass the request to memory sub-system controller firmware, which can modify the request as appropriate.

By automating the determination of a corresponding RG associated with a PHI by a hardware component of a memory sub-system controller, advantages of the present disclosure include improved performance by reducing write amplification and improving memory device system performance. Furthermore, the configurability of the memory sub-system parameters for FDP mode improve the quality of service for the host system.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110. The host system 120 can include one or more submission queues 123A to 123N. Each submission queue 123A to 123N can be a data structure (e.g., a table) with one or more entries, where each entry stores a memory access command. The host system can include one or more completion queues 121A to 121N. Each completion queue 121A to 121N can be a data structure (e.g., a table) with one or more entries, where each entry stores a notification of a completion of execution of a memory access command. The one or more submission queues 123A to 123N and/or the one or more completion queues 121A to 121N can be coupled to and/or otherwise accessible to the host system 120.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Pillar, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a not-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level memory cells (SLC) can store one bit per memory cell. Other types of memory cells, such as multi-level memory cells (MLCs), triple level memory cells (TLCs), quad-level memory cells (QLCs), and penta-level memory cells (PLCs) can store multiple bits per memory cell. In some embodiments, each of the memory devices 130 can include one or more arrays of memory cells such as SLCs, MLCs, TLCs, QLCS, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130.

The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local controller 132) on the die and a controller (e.g., memory sub-system controller 115) for media management within the same memory device package. An example of a managed memory device is a managed NAND (MNAND) device.

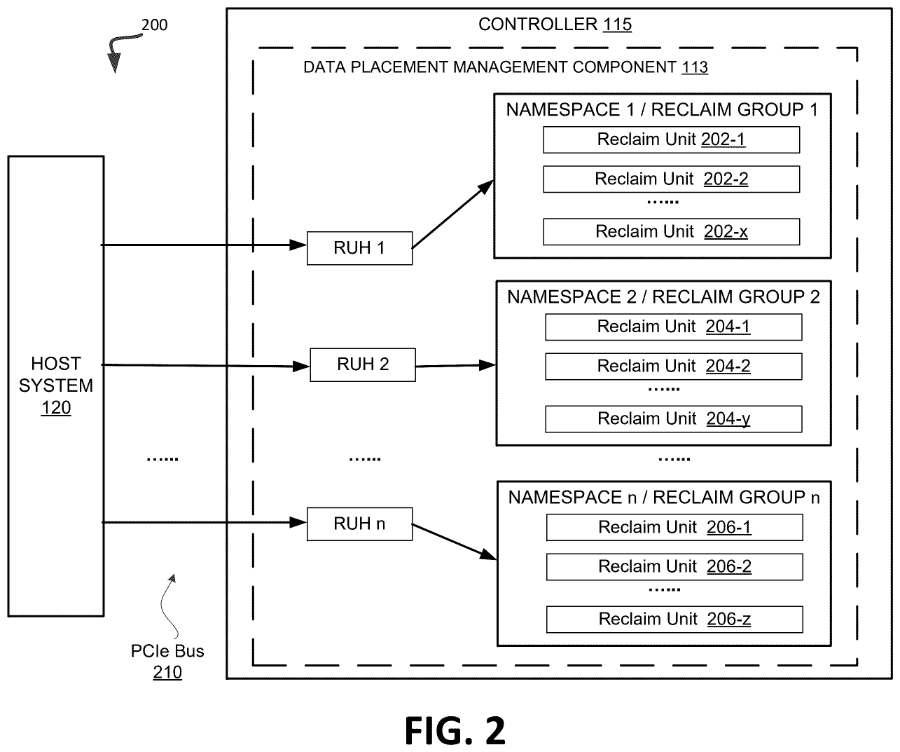

The memory sub-system 110 includes a data placement management component 113 that can be used to implement managing data placement in a memory sub-system, in accordance with embodiments of the present disclosure. The data placement management component 113 can include a firmware component 113a and a hardware component 113b. The hardware component 113b can be circuitry of the memory sub-system controller 115 that is used to transmit and receive data to and from the memory devices 130, 140 of the memory sub-system 110. The firmware component 113a can be the firmware of the memory sub-system controller 115 that provides some control to the hardware component 113b of the memory sub-system controller 115. In some embodiments, the memory sub-system controller 115 includes at least a portion of the data placement management component 113. In some embodiments, the data placement management component 113 is part of the host system 110, an application, or an operating system. In other embodiments, local media controller 135 includes at least a portion of data placement management component 113 and is configured to perform the functionality described herein. Further details regarding implementing managing command completion notification pacing in a memory sub-system are described herein below with reference to FIGS. 2-5.

It will be appreciated by those skilled in the art that additional circuitry and signals can be provided, and that the components of FIG. 1 have been simplified. It should be recognized that the functionality of the various block components described with reference to FIG. 1 may not necessarily be segregated to distinct components or component portions of an integrated circuit device. For example, a single component or component portion of an integrated circuit device could be adapted to perform the functionality of more than one block component of FIG. 1. Alternatively, one or more components or component portions of an integrated circuit device could be combined to perform the functionality of a single block component of FIG. 1.

FIG. 2 illustrates a virtualization internal management component in a memory sub-system in accordance with some embodiments of the present disclosure. The system 200 can include the host system 120, one or more memory devices (not shown), and a controller 115 that is operatively coupled with the memory devices. In one embodiment, the controller 115 of memory sub-system 110 is connected to host system 120 over a physical host interface, such as PCIe bus 210. The controller 115 can expose the different portions of the memory devices to virtual machines through various techniques, including single root input/output virtualization (SrIOV), multiple physical functions (MPF), and scalable I/O virtualization (sIOV or scalable IOV). Using these techniques, the controller 115 can present two or more physical or virtual functions (PFs/VFs) or assignable device interfaces (ADIs) to the host system 120 over an interconnect, such as a PCIe interface. The host system 120 can assign each of the PFs/VFs/ADIs to individual applications, virtual machines, or the like. The host system 120 can request the number of PFs/VFs/ADIs needed. In some embodiments, each of the PFs/VFs/ADIs corresponds to a virtual memory controller that is associated with a different portion of the memory devices.

For example, the controller 115 can manage a number of physical functions (PFs). Physical functions are fully featured PCIe functions that can be discovered, managed, and manipulated like any other PCIe device, and thus can be used to configure and control a PCIe device. Each physical function is a PCI function that supports the virtualization capabilities, and thus physical functions can each allow the enumeration of a number of virtual functions (VFs). The controller 115 can also manage virtual functions, virtual controllers, or the like to present themselves as physical functions and physical controllers to other devices, such as host system 120, connected to PCIe bus 210 by virtue of the physical function. The virtual functions can be lightweight PCIe functions that share one or more resources with one physical function and with virtual functions that are associated with that physical function. For example, the PCI configuration space of each virtual function can be accessed by a bus, device, and function (BDF) number of the physical function. Each virtual function can have a PCI memory space, which is used to map its register set. The virtual function device drivers operate on a register set to enable its functionality and the virtual function appears as an actual PCIe device, accessible by host system 120 over PCIe bus 210.

The controller 115 can create a set of namespaces by allocating physically-separate segments of storage to different namespaces. In other words, the namespaces are created so that operations performed on the namespaces would have minimum interference over each other. In some implementations, reclaim units (RUs) in Flexible Data Placement (FDP) are used. RUs are units of physical, non-volatile storage that can be programmed, read, erased, reused, or repurposed without disturbing each other. Specifically, the controller 115 can select, for each namespace, a set of RUs to form a reclaim group (RG) and map the RG to the namespace. For example, a first set of RUs is located in Die 1, and a second set of RUs is located in Die 2; the controller 115 may select the first set of RUs to form a first RG and map the first RG to the Namespace 1, and the controller 115 may select the second set of RUs to form a second RG and map the second RG to the Namespace 2. In some embodiments, the number of namespaces can be preconfigured at manufacturing based on offline testing and media characterization of the memory device. In some embodiments, the number of the set of RUs that can be mapped to namespaces can be preconfigured at manufacturing based on offline testing and media characterization of the memory device.

After the controller 115 creates one or more namespaces, the controller 115 can assign one reclaim unit handle (RUH) to each namespace. The RUH can be used to point to the RG that is mapped to the namespace, thus pointing to the set of RUs in the RG. The RUH is unique to the specific namespace, and the specific namespace can only have one RUH. Although RUH is used here, other forms of handles, tags, etc. can be used to replace RUH. For example, a cursor identifier can be used to reference a function.

In some implementations, the controller 115 can store the assignment of the RUH to the namespace (e.g., identified by a placement handle identifier (PHI)) in a data structure. The data structure can also include a mapping of each RUs or a range of RUs to a particular PHI. In some implementations, the data structure include one or more entries, including a PHI, a RUH, a set of RUs (e.g., identified by physical addresses), an RG (e.g., identified by a physical address), a RU granularity (e.g., represented by a size), a size of an RG. The RUH can be used to identify a namespace to which it is assigned. The PHI can be used to identify a specific set of RUs to which the namespace is mapped. The RU granularity can identify a size of one RU. In some embodiments, each namespace can have a RU granularity with a differing size than another namespace. In some embodiments, each namespace can have a RU granularity with the same size as another namespace or each namespace. The size of RG can represent the memory size provided by the namespace. In some embodiments, the size of RG can be up to the drive capacity of the memory device. In some embodiments, the size of RG is defined by a host system of the memory sub-system. In some embodiments, the size of RG is preconfigured at manufacturing based on offline testing and media characterization of the memory device. The set of RUs can be used to identify the segment of the memory device to perform the operation. Specifically, the controller 115 can retrieve (e.g., from an entry of the data structure) an RUH that corresponds to the particular PHI. For example, the controller 115 can identify an entry of the data structure that stores the particular PHI, and, in response to identifying the entry that stores the particular PHI, the controller 115 can identify the corresponding RUH stored in the entry. The controller 115 can, in response to identifying the corresponding RUH stored in the entry, identify the corresponding set of RUs and/or the RG comprising the set of RUs stored in the entry. The controller 115 can perform the operation at the physical addresses at which the set of RUs and/or the RG is located.

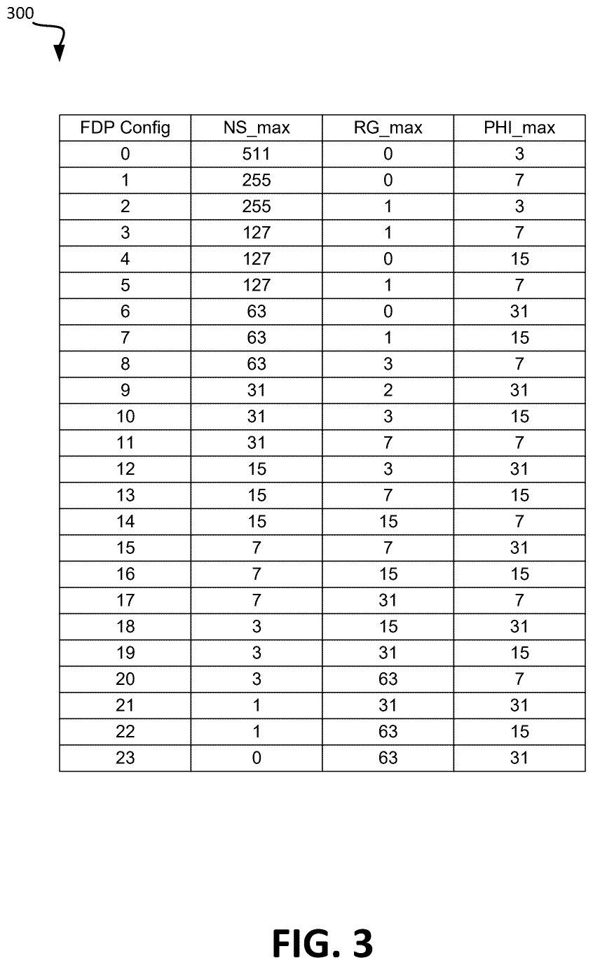

In one embodiment, the FDP configurations implemented by controller 115 are configurable via negotiation with the host system 120. For example, the host system 120 can specify a particular configuration for the controller 115 to implement, where each configuration can include a different combination of parameter values. FIG. 3 is chart 300 illustrating different example FDP configurations that can be implemented by controller 115 in accordance with some embodiments of the present disclosure. In the illustrated embodiment, the parameters include the maximum number of namespaces (i.e., NS_max) supported in the FDP mode, the maximum number of reclaim groups (i.e., RG_max) supported in the FDP mode, and the maximum number of placement handle identifiers (i.e., PHI_max) supported in the FDP mode. There may be a practical limit to the storage provided by the memory sub-system, such that if one parameter is increased, another parameter may need to be decreased. Note that in chart 300, the parameter values are all zero-based (i.e., a value of zero represents one, a value of 15 represents 16, etc.). For example, if host system 120 requests that the maximum number of namespaces be 256, then there is the option to have either the maximum number of reclaim groups be 1 and the maximum number of placement handle identifiers be 8 (i.e., FDP configuration 1), or to have the maximum number of reclaim groups be 2 and the maximum number of placement handle identifiers be 4 (i.e., FDP configuration 2). Similarly, if host system 120 requests that the maximum number of namespaces be 8 then there is the option to have either the maximum number of reclaim groups be 8 and the maximum number of placement handle identifiers be 32 (i.e., FDP configuration 15), to have the maximum number of reclaim groups be 16 and the maximum number of placement handle identifiers be 16 (i.e., FDP configuration 16), or to have the maximum number of reclaim groups be 32 and the maximum number of placement handle identifiers be 8 (i.e., FDP configuration 17).

Referring again to FIG. 2, once the FDP configuration is set, the controller 115 can receive a command (e.g., a data access request) from host system 120 over PCIe bus 210, including a request to read, write, or erase data in a portion of a memory device (e.g., memory device 130). The command can specify a namespace in which the operation to read, write, or erase data would be performed (e.g., using a PHI). Responsive to receiving, by the controller 115, the command from the host system 120, the data placement management component 113 (e.g., a hardware component) can identify a RUH that is assigned to the namespace specified by the command. The RUH can be used to point to the RG that is mapped to the namespace, thus pointing to the set of RUs in the RG namespace. The data placement management component 113 can identify an RG using the RUH, and the RG represents a segment of the memory device where the operation to write, read, or erase data will be performed.

The controller 115 can perform the operation specified by the command on the segment of the memory device. In some implementations, the controller 115 can identify a specific RU within the RG to perform the operation. For example, the controller 115 may identify the specific RU as the last-written place in the RG and continue writing on the specific RU for a write operation.

As shown in the example of FIG. 2, the controller 115 creates namespace 1 by allocating the reclaim group 1, where the reclaim group 1 includes reclaim units 202-1, 202-2, . . . 202-x; the controller 115 creates namespace 2 by allocating the reclaim group 2, where the reclaim group 2 includes reclaim units 204-1, 204-2, . . . 204-y; the controller 115 creates namespace n by allocating the reclaim group n, where the reclaim group n includes reclaim units 206-1, 206-2, . . . 206-z. The controller 115 assigns RUH 1 to namespace 1, RUH 2 to namespace 2, and RUH n to namespace n. The controller 115 can receive, from host system 120 over PCIe bus 210, a command to write data in a portion of a memory device, where the command can specify namespace 1, and the data placement management component 113 can identify RUH 1 that is assigned to namespace 1, where RUH 1 points to reclaim group 1. The controller can decide a specific location in the reclaim group 1 to write data specified in the command. Similarly, the controller 115 can receive, from host system 120 over PCIe bus 210, a command to write data in a portion of a memory device, where the command can specify namespace 2, and the data placement management component 113 can identify RUH 2 that is assigned to namespace 2, where RUH 2 points to reclaim group 2.

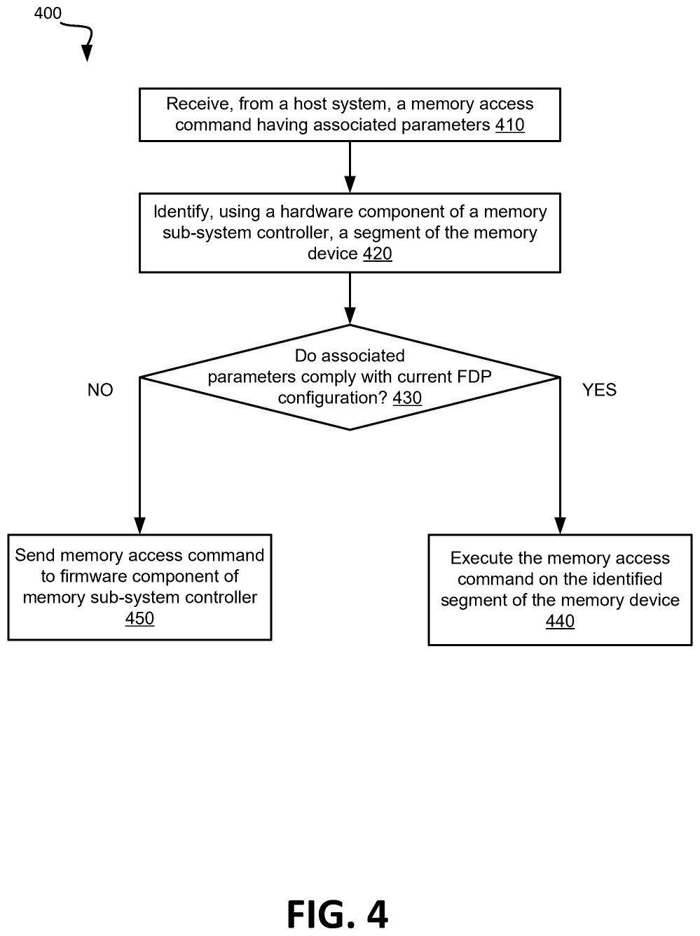

FIG. 4 is a flow diagram of an example method 400 to implement data placement in a memory sub-system, in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the data placement management component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, the processing logic receives a memory access command at a memory sub-system controller (e.g., the memory sub-system controller 115 of FIG. 1). In some embodiments, the memory access command is a write command. The processing logic can receive the memory access command from the host device (e.g., the host system 120 of FIG. 1). For example, the memory access command can receive the memory access command via an interface port coupled to the memory sub-system controller and the host device. Examples of interface ports include a serial advanced technology attachment (SATA) interface, a peripheral component interconnect express (PCIe) interface, universal serial bus (USB) interface, Fibre Channel, Serial Attached SCSI (SAS), etc. The host device can further utilize an NVM Express (NVMe) interface to access the memory sub-system controller when the memory sub-system is coupled with the host device by the PCIe interface. The interface port can provide an interface for passing control, address, data, and other signals between the memory sub-system and the host device. The memory sub-system can include multiple interface ports. In some embodiments, the processing logic can retrieve the memory access command from an entry of a data structure, such as a table storing memory access commands from the host device in each entry (e.g., a submission queue). In some embodiments, the data structure can be a submission queue 123A to 123N, as illustrated in FIG. 1. In some embodiments, the memory access command can be associated with one or more parameters, including for example, a placement handle identifier (PHI) and/or a segment identifier. For example, the one or more parameters can indicate a namespace to which the memory access command is directed, the PHI, and a reclaim group. The segment identifier can correspond to a namespace of a set of namespaces of the memory device. Each namespace, as described with respect to FIG. 2, can include a reclaim group, where each reclaim group includes a set of reclaim units. In some embodiments, each namespace can be assigned (e.g., by a memory sub-system controller and/or firmware component) to a reclaim unit handle, where the reclaim unit handle is unique to the namespace, and the namespace is unique to the reclaim unit handle. In some embodiments, the segment identifier can correspond to a cursor identifier of a set of cursor identifiers of the memory device. Each cursor identifier can be associated with a corresponding function of the memory device. In some embodiments, the segment identifier can correspond to either a namespace or a cursor identifier based on a configuration setting of the memory device. In some embodiments, the configuration setting can be a static configuration that is set during a design phase of the memory device based on offline testing and media characterization.

At operation 420, the processing logic identifies a segment of the memory device based on the segment identifier received at operation 410. In some embodiments, the segment of the memory device is identified using a hardware component (e.g., a hardware automation component and/or the hardware component 113b of FIG. 1) of the memory sub-system controller. In some embodiments, identifying the segment of the memory device is performed in response to determining that the configuration setting is enabled for identifying the segment of the memory device using the hardware component. In some embodiments, determining whether the configuration setting is enabled can include reading one or more registers associated with the host device, where the one or more registers store data specifying the configuration setting. In some embodiments, determining whether the configuration setting is enabled can include reading the metadata associated with the memory access command received from the host device. In some embodiments, the configuration setting is specified by the host device and stored in one or more registers associated with the host device and accessible to the memory sub-system. In some embodiments, the configuration setting is preconfigured at manufacturing based on device requirements/specifications and/or customer/business requirements. In some embodiments, identifying the segment of the memory device based on the segment identifier can include identifying the reclaim unit handle assigned to the particular namespace using a data structure mapping respective reclaim unit handles to respective namespaces (e.g., the data structure described with respect to FIG. 2). In some embodiments, the data structure includes a set of entries, where each entry maps (e.g., stores a logical association) a respective reclaim unit to a respective PHI and a respective set of reclaim units included in a respective reclaim group. The processing logic can retrieve, from an entry of the data structure, a reclaim unit handle corresponding to the segment identifier (e.g., to the particular PHI), wherein the reclaim unit handle identifies a set of reclaim units included in a reclaim group. For example, the processing logic can identify an entry of the data structure that stores the particular PHI. In response to identifying the entry that stores the particular PHI, the processing logic can identify the corresponding reclaim unit handle that corresponds to (e.g., is logically associated with) the particular PHI. In response to identifying the reclaim unit handle, the processing logic can identify the corresponding set of RUs and/or the corresponding RG that is stored in the entry and is logically associated with the reclaim unit handle and the PHI in the data structure.

At operation 430, the processing logic determines whether the one or more associated parameters comply with a current flexible data placement (FDP) configuration of the memory sub-system 110. As described herein, the FDP configuration can be set previously based on input from the host system 120, and can include for example, a maximum number of namespaces supported in the memory sub-system 110, a maximum number of placement handle identifiers supported in the memory sub-system 110, and a maximum number of reclaim groups supported in the memory sub-system 110. To determine whether the one or more associated parameters from the memory access command comply with the current FDP configuration, the hardware component (e.g., a hardware automation component and/or the hardware component 113b of FIG. 1) can compare the values of the one or more associated parameters with the maximum values that define the FDP configuration.

In response to determining that the one or more associated parameters comply with the current FDP configuration of the memory sub-system 110, at operation 440, the processing logic executes the memory access command received at operation 410 on the identified segment (e.g., at a physical address at which the set of RUs and/or the RG identified at operation 420 is located). In some embodiments, the processing logic executes the memory access command using a firmware component (e.g., the firmware component 113a of FIG. 1) and/or hardware component (e.g., the hardware component 113b of FIG. 1) of the memory sub-system controller. In some embodiments, executing the memory access command can include identifying a logical block address of the memory access command. The logical block address can be identified using the logical address information included in, e.g., metadata associated with the memory access command. The processing logic (e.g., the hardware component) can convert the logical block address into one or more translation units (TU). The processing logic can identify a pointer of each TU of the one or more TUs, where each pointer points to a location in the memory device of the data identified by each TU. The pointer can point to the location of the identified segment in the memory device. The processing logic can execute the memory access command by executing each TU of the one or more TUs using the pointer of each TU. For example, the processing logic can write the data identified by a particular TU to the location in the memory device identified by the pointer of the particular TU.

In some embodiments, the hardware component sends the identified segment of the memory device to the firmware component. In response to receiving the identified segment of the memory device, the firmware component can update a corresponding entry of the logical-to-physical (L2P) table with the identified segment on which the memory access command is executed.

In some embodiments, the processing logic notifies the host device of completion of execution of the memory access command. In some embodiments, notifying the host device of the completion of the execution of the memory access command can include updating an entry of a data structure coupled to and/or otherwise associated with the host device with a notification of the completion of the execution. In some embodiments, updating the entry of the data structure can include updating the entry with an identifier of the memory access command (e.g., the logical address information of the memory access command). In some embodiments, the processing logic can send an interrupt message to the host device. In some embodiments, the interrupt message can include data indicating that the entry of the L2P table has been updated. In some embodiments, the interrupt message is an electrical signal that interrupts the host device. In some embodiments, the interrupt message can be sent using an interrupt routine.

In response to determining that the one or more associated parameters do not comply with the current FDP configuration of the memory sub-system 110, at operation 450, the processing logic sends the memory access command to a firmware component (e.g., firmware component 113a) of the memory sub-system controller 115. The firmware component is configured to generate a modified memory access command and execute the modified memory access command on the memory device 130. To modify the memory access command, the firmware component may adjust one or more of the associated parameters to comply with the current FDP configuration. For example, the firmware component may change the PHI and the reclaim group to default parameters (e.g. 0). In one embodiment, upon modifying the memory access command, the firmware component sends the modified memory access command back to the hardware component 113b for execution.

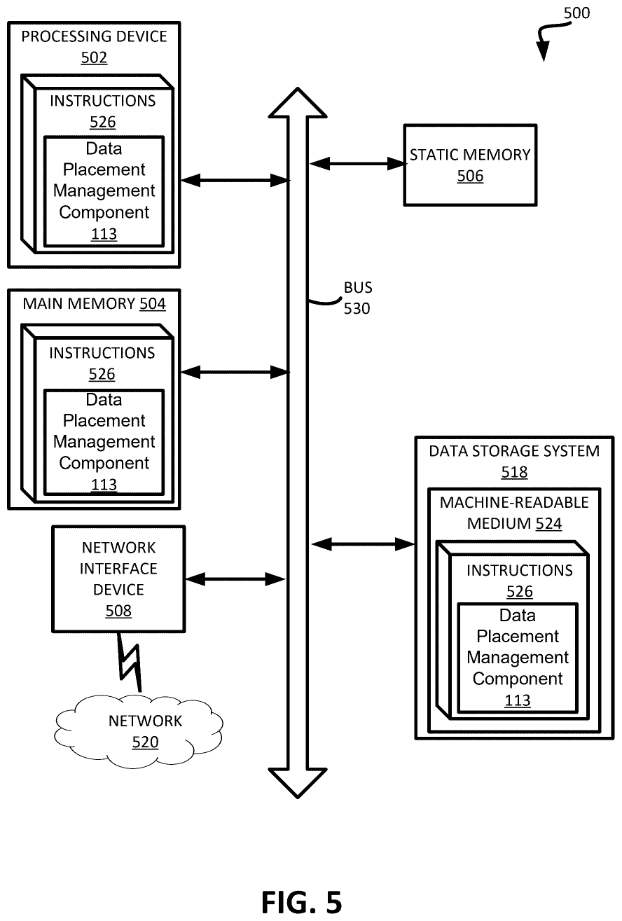

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the data placement management component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a memory cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or RDRAM, etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In one embodiment, the instructions 526 include instructions to implement functionality corresponding to a component (e.g., data placement management component 113 of FIG. 1). While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device; and
a memory sub-system controller, operatively coupled with the memory device, to perform operations comprising:
receiving, from a host system, a memory access command having one or more associated parameters;
determining, using a hardware component of the memory sub-system controller, whether the one or more associated parameters comply with a current flexible data placement (FDP) configuration of the system; and
in response to determining that the one or more associated parameters comply with the current FDP configuration of the system, executing the memory access command on an identified segment of the memory device.

2. The system of claim 1, wherein the one or more associated parameters correspond to a namespace of the memory device.

3. The system of claim 2, wherein the namespace comprises a reclaim group, wherein the reclaim group comprises a plurality of reclaim units, wherein the namespace has an associated reclaim unit handle, and wherein the reclaim unit handle is unique to the namespace and the namespace is unique to the reclaim unit handle.

4. The system of claim 3, wherein the memory sub-system controller is to perform operations further comprising:
identifying the segment of the memory device, wherein identifying the segment comprises retrieving, from a data structure, a reclaim unit handle, wherein the reclaim unit handle identifies a plurality of reclaim units, and wherein the data structure comprises a plurality of entries, each entry mapping a respective reclaim unit to a respective namespace and a respective plurality of reclaim units.

5. The system of claim 1, wherein the memory sub-system controller is to perform operations further comprising:
in response to determining that the one or more associated parameters do not comply with the current FDP configuration of the system, sending the memory access command to a firmware component of the memory sub-system controller, wherein the firmware component is to generate a modified memory access command and execute the modified memory access command on the memory device.

6. The system of claim 1, wherein the current FDP configuration of the memory sub-system comprises a maximum number of namespaces supported in the memory sub-system, a maximum number of placement handle identifiers supported in the memory sub-system, and a maximum number of reclaim groups supported in the memory sub-system.

7. The system of claim 1, wherein the current FDP configuration of the memory sub-system is configurable by the host system.

8. A method comprising:
receiving, at a memory sub-system and from a host system, a memory access command having one or more associated parameters;
determining, using a hardware component of a memory sub-system controller of the memory sub-system, whether the one or more associated parameters comply with a current flexible data placement (FDP) configuration of the memory sub-system; and
in response to determining that the one or more associated parameters comply with the current FDP configuration of the memory sub-system, executing the memory access command on an identified segment of a memory device of the memory sub-system.

9. The method of claim 8, wherein the one or more associated parameters correspond to a namespace of the memory device.

10. The method of claim 9, wherein the namespace comprises a reclaim group, wherein the reclaim group comprises a plurality of reclaim units, wherein the namespace has an associated reclaim unit handle, and wherein the reclaim unit handle is unique to the namespace and the namespace is unique to the reclaim unit handle.

11. The method of claim 10, further comprising:
identifying the segment of the memory device, wherein identifying the segment comprises retrieving, from a data structure, a reclaim unit handle, wherein the reclaim unit handle identifies a plurality of reclaim units, and wherein the data structure comprises a plurality of entries, each entry mapping a respective reclaim unit to a respective namespace and a respective plurality of reclaim units.

12. The method of claim 8, further comprising:
in response to determining that the one or more associated parameters do not comply with the current FDP configuration of the system, sending the memory access command to a firmware component of the memory sub-system controller, wherein the firmware component is to generate a modified memory access command and execute the modified memory access command on the memory device.

13. The method of claim 8, wherein the current FDP configuration of the memory sub-system comprises a maximum number of namespaces supported in the memory sub-system, a maximum number of placement handle identifiers supported in the memory sub-system, and a maximum number of reclaim groups supported in the memory sub-system.

14. The method of claim 8, wherein the current FDP configuration of the memory sub-system is configurable by the host system.

15. A non-transitory computer-readable storage medium storing instructions which, when executed by a processing device, cause the processing device to perform operations comprising:
receiving, at a memory sub-system and from a host system, a memory access command having one or more associated parameters;
determining, using a hardware component of a memory sub-system controller of the memory sub-system, whether the one or more associated parameters comply with a current flexible data placement (FDP) configuration of the memory sub-system; and
in response to determining that the one or more associated parameters comply with the current FDP configuration of the memory sub-system, executing the memory access command on an identified segment of a memory device of the memory sub-system.

16. The non-transitory computer-readable storage medium of claim 15, wherein the one or more associated parameters correspond to a namespace of the memory device.

17. The non-transitory computer-readable storage medium of claim 16, wherein the namespace comprises a reclaim group, wherein the reclaim group comprises a plurality of reclaim units, wherein the namespace has an associated reclaim unit handle, and wherein the reclaim unit handle is unique to the namespace and the namespace is unique to the reclaim unit handle.

18. The non-transitory computer-readable storage medium of claim 17, wherein the instructions cause the processing device to perform operations further comprising:
identifying the segment of the memory device, wherein identifying the segment comprises retrieving, from a data structure, a reclaim unit handle, wherein the reclaim unit handle identifies a plurality of reclaim units, and wherein the data structure comprises a plurality of entries, each entry mapping a respective reclaim unit to a respective namespace and a respective plurality of reclaim units.

19. The non-transitory computer-readable storage medium of claim 15, wherein the instructions cause the processing device to perform operations further comprising:
in response to determining that the one or more associated parameters do not comply with the current FDP configuration of the system, sending the memory access command to a firmware component of the memory sub-system controller, wherein the firmware component is to generate a modified memory access command and execute the modified memory access command on the memory device.

20. The non-transitory computer-readable storage medium of claim 15, wherein the current FDP configuration of the memory sub-system comprises a maximum number of namespaces supported in the memory sub-system, a maximum number of placement handle identifiers supported in the memory sub-system, and a maximum number of reclaim groups supported in the memory sub-system.
